(19) United States
(12) Patent Application Publication
(10) Pub. No.: US 2025/0340370 A1
(43) Pub. Date: Nov. 6, 2025

(54) PACKING SYSTEM PAUSE ON NON-WASTE DETECTION

(71) Applicant: Oshkosh Corporation, Oshkosh, WI (US)

(72) Inventors: Eric Olsen, Oshkosh, WI (US); John Zucca, Oshkosh, WI (US); Brendan Chan, Oshkosh, WI (US); Leo Van Kampen, Conestogo (CA); Jeremy Bernard, Oshkosh, WI (US)

(73) Assignee: Oshkosh Corporation, Oshkosh, WI (US)

(21) Appl. No.: 19/197,375

(22) Filed: May 2, 2025

Related U.S. Application Data
(60) Provisional application No. 63/642,166, filed on May 3, 2024.

(51) Int. Cl. B65F 3/20; B65F 3/14

(52) U.S. Cl. CPC B65F 3/20; B65F 2003/146

(57) ABSTRACT

A refuse vehicle is described, comprising a body with a refuse compartment, a hopper for receiving refuse, an actuator for directing refuse within the body, a sensor mounted on the vehicle, and processing circuitry. The processing circuitry is configured to capture sensor data of an object using the sensor, identify the object as non-refuse based on the sensor data, and upon detection of the object as non-refuse, send commands to adjust the actuator's motion.

### CROSS-REFERENCE TO RELATED PATENT APPLICATIONS

This application claims the benefit of and the priority to U.S. Provisional Patent Application No. 63/642,166, filed May 3, 2024, the entire disclosure of which is incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

In some aspects, the techniques described herein relate to a refuse vehicle including: a body defining a refuse compartment; a hopper configured to receive refuse; an actuator; a sensor coupled to the refuse vehicle; one or more processors; and computer-readable, non-transitory storage medium including instructions that when executed by the one or more processors cause the one or more processors to perform method including: receiving, from the sensor, a perception dataset of a perception area proximate to or within the refuse compartment; detecting an object within the perception area based at least in part on the perception dataset; classifying the object based at least in part on the perception dataset; and in response to classifying the object as not refuse, transmitting a control signal to adjust an operation of the actuator.

In some aspects, the techniques described herein relate to a refuse vehicle, wherein the method further includes: transmitting instructions to display an alert identifying the object as non-refuse; receiving an override indication identifying the object as refuse; and in response to receiving the override indication, transmitting to the actuator, a second control signal to resume operation of the actuator.

In some aspects, the techniques described herein relate to a refuse vehicle, wherein the sensor is an RFID sensor.

In some aspects, the techniques described herein relate to a refuse vehicle, wherein the object is a wearable device communicably coupled to the sensor.

In some aspects, the techniques described herein relate to a refuse vehicle, wherein the wearable device communicates with the sensor through one of RFID, WiFi, and Bluetooth.

In some aspects, the techniques described herein relate to a refuse vehicle, wherein the actuator directs the refuse from the hopper to the refuse compartment.

In some aspects, the techniques described herein relate to a refuse vehicle, wherein the actuator is a compactor for compacting the refuse within the refuse compartment.

In some aspects, the techniques described herein relate to a refuse vehicle, wherein the actuator is a lift assembly for directing the refuse into the hopper.

In some aspects, the techniques described herein relate to a refuse vehicle, wherein the control signal includes instructions to at least one of stop the actuator, reverse direction of the actuator, and adjust operation of the actuator.

In some aspects, the techniques described herein relate to a refuse vehicle, wherein the actuator is at least one of a front loading arm, a side loading arm, an ejector, or a compactor.

In some aspects, the techniques described herein relate to a computer-readable, non-transitory storage medium including instructions that when executed by one or more processors, cause the one or more processors to execute a method including: receiving, from a sensor, a perception dataset of a perception area proximate to or within a refuse compartment of a refuse vehicle; detecting an object within the perception area based at least in part on the perception dataset; classifying the object based at least in part on the perception dataset; and in response to classifying the object as not refuse, transmitting a control signal to adjust an operation of an actuator of the refuse vehicle.

In some aspects, the techniques described herein relate to a computer-readable, non-transitory storage medium, wherein the method further includes: transmitting instructions to display an alert identifying the object as non-refuse; receiving an override indication identifying the object as refuse; and in response to receiving the override indication, transmitting to the actuator, a second control signal to resume operation of the actuator.

In some aspects, the techniques described herein relate to a computer-readable, non-transitory storage medium, wherein the sensor is an RFID sensor.

In some aspects, the techniques described herein relate to a computer-readable, non-transitory storage medium, wherein the object is a wearable device communicably coupled to the sensor.

In some aspects, the techniques described herein relate to a computer-readable, non-transitory storage medium, wherein the wearable device communicates with the sensor through one of RFID, WiFi, and Bluetooth.

In some aspects, the techniques described herein relate to a computer-readable, non-transitory storage medium, wherein the actuator directs refuse from a hopper of the refuse vehicle to the refuse compartment of the refuse vehicle.

In some aspects, the techniques described herein relate to a computer-readable, non-transitory storage medium, wherein the actuator is a compactor for compacting refuse within the refuse compartment.

In some aspects, the techniques described herein relate to a computer-readable, non-transitory storage medium, wherein the actuator is a lift assembly for directing refuse into a hopper of the refuse vehicle.

In some aspects, the techniques described herein relate to a computer-readable, non-transitory storage medium, wherein the control signal includes instructions to at least one of stop the actuator, reverse direction of the actuator, and adjust operation of the actuator.

In some aspects, the techniques described herein relate to a refuse vehicle including: a body defining a refuse compartment; a hopper configured to receive refuse; an actuator; a camera coupled to the refuse vehicle; one or more processors; and computer-readable, non-transitory storage medium including instructions that when executed by the one or more processors cause the one or more processors to perform method including: receiving, from the camera, a perception dataset of a perception area proximate to or within the refuse compartment; detecting an object within the perception area based at least in part on the perception dataset; classifying the object based at least in part on the perception dataset; and in response to classifying the object as not refuse, transmitting instructions to adjust an operation of the actuator.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment; and

FIG. 2 is a block diagram of a vehicle, according to an exemplary embodiment.

FIG. 3 is a block diagram of a control system of a refuse vehicle, according to an exemplary embodiment.

FIG. 4 is a block diagram of a non-refuse detection system of a refuse vehicle, according to an exemplary embodiment.

FIG. 5 is a perspective view of a refuse vehicle equipped with a non-refuse detection system, according to an exemplary embodiment.

FIG. 6 illustrates a user interface of a refuse vehicle equipped with a non-refuse detection system, according to an exemplary embodiment.

FIG. 7 is a side-view, section view of a compaction compartment of a refuse vehicle equipped with a non-refuse detection system.

FIG. 8 is a flowchart of a method for adjusting operation of a refuse vehicle in response to detecting a non-refuse object within a hopper of the vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

The systems and methods described herein may relate, in some implementations, to adjusting an auxiliary function (e.g., compaction, refuse collection, ejection) of a refuse vehicle (referred to herein as a vehicle) upon detection of a non-refuse object within or near the refuse vehicle. In one or more implementations, one or more sensors monitor a perception area proximate to or within a refuse compartment of the vehicle, and the resulting sensor data (a perception dataset) is analyzed to determine whether any detected object is a non-refuse object.

For example, the vehicle may include a hopper into which collected refuse is stored prior to a compaction process. The vehicle may include a sensor, such as a camera, that captures data of objects within the hopper at periodic intervals and transmits the captured data to an image processing device. The captured data is processed by the image processing device and analyzed to determine an object type of one or more objects within the hopper. Upon determining a non-refuse object within the hopper, the image processing device transmits an indication of the non-refuse object to a controller to transmit control signal instructions to cease operation of the auxiliary function. The instructions may include instructions to pause operation and/or reverse the operation of the auxiliary function. In some embodiments, the controller may require receipt of a secondary indication (e.g., an alert override) of an override indication identifying the object as refuse (e.g., an alert override) from a user input prior to reinitiating the auxiliary function.

According to at least one exemplary embodiment of the systems and methods described herein, a refuse vehicle is equipped with an intelligent packing system that is configured to halt or cease packing operations upon detecting non-refuse objects within a hopper of the refuse vehicle. The system integrates a machine vision technology trained to distinguish between various types of refuse and non-refuse items. Upon identification of non-refuse objects, the machine vision system can send commands to the pack actuator to stop packing using one or more communication methods. Depending on the implementation, the machine vision system may function as a separate module communicating with the refuse vehicle controller via Analog, CAN (SAE J1939), Ethernet, or USB connections, or it may be integrated into the vehicle controller itself. In case of detecting non-refuse material, the system is configured to automatically pause or stop packing until a manual override confirms only waste is present in the hopper. User input to interfaces such as touch screens, joysticks, or keypad/buttons may indicate this confirmation, which is sent to the controller of the vehicle. Alternatively, video streaming to a telematics portal allows remote verification of hopper clearance, with an all-clear signal sent via telematics. Additionally, operator presence detection within the hopper or compaction compartment can be performed through the use of wearable devices using RFID, WIFI, Bluetooth, etc., enhancing operational safety and efficiency.

In one example, a municipal refuse collection vehicle is operating along a residential route and collects refuse from a street-side container using a side-loading lift assembly. As the contents of the container are dumped into the hopper, a camera mounted above the hopper captures a series of image frames representing the incoming material. The image data is analyzed in real time by an onboard object detection system that includes a convolutional neural network trained to identify hazardous or non-refuse items. During the analysis, the system detects a metallic cylindrical object exhibiting geometry and reflectivity consistent with an aerosol can—an item prohibited by the municipal waste guidelines due to potential explosive hazard during compaction. In response, the object detection system classifies the item as non-refuse and transmits a signal to the vehicle controller. The controller, executing auxiliary control logic, issues a command to immediately pause the compaction sequence and prevent further movement of the packer blade. Simultaneously, the vehicle's human-machine interface displays a visual alert indicating that a prohibited object has been detected. The operator is prompted to review the hopper via an in-cab display showing the most recent camera feed. If the operator visually verifies that the object is non-hazardous (e.g., an empty aluminum can), the operator may press an override button on the interface, causing the controller to clear the alert and resume the compaction cycle. Alternatively, if the object poses a real threat or cannot be verified, the operator may engage a manual ejection protocol to clear the hopper prior to resuming standard collection operations.

In another example, a rear-loading refuse vehicle is servicing a densely populated urban area during early morning collection hours. An operator wearing a safety vest embedded with an RFID tag is tasked with manually positioning refuse carts for pickup. As the operator moves behind the vehicle to inspect a partially filled cart that was manually dumped into the hopper, the RFID sensor mounted at the rear of the vehicle detects the presence of the operator's tag within a defined perception area corresponding to the hopper's interior boundary. The RFID detection system transmits a signal to the vehicle controller identifying the RFID tag's proximity and position relative to the hopper.

In response to the detection, the controller interprets the RFID signature as corresponding to a wearable device associated with a human operator and classifies the object as non-refuse. Based on this classification, the controller executes instructions stored on a computer-readable, non-transitory storage medium to immediately pause the compaction sequence and issue a lockout command to prevent activation of the hopper actuator and ejector mechanisms. Simultaneously, an alert is generated and displayed on the in-cab touchscreen interface to inform the driver of the potential human presence in the hopper region.

The system remains in a paused state until a valid override is received. In this case, the operator, having safely stepped away from the hopper, taps an external override panel mounted on the rear corner of the vehicle. This input is received through the human-machine interface, which then clears the alert and transmits a resume signal to the auxiliary control system. Compaction operations safely recommence thereafter. This approach prevents accidental injury due to operator proximity and enables safe operation of manual and automated procedures during dynamic collection workflows.

In another example, the system may detect a live animal among the refuse contents in the hopper. In this case, the animal appears in the perception dataset captured by the hopper camera, and the object detection system 404 will classify the animal as a non-refuse object. The controller 302 triggers a halt of the compaction actuator, effectively pausing the compaction process. The controller 302 also transmits instructions to display an alert identifying the object as non-refuse on the operator's interface (e.g., a message such as “Animal detected—compaction paused”). The operator may then intervene to safely remove or coax the animal out of the hopper. Once the hopper is confirmed to be clear of the animal and the operator provides the appropriate override input, the system receives an override indication identifying the object as refuse. In response, the controller issues a second control signal to resume operation of the actuator, thereby allowing the refuse vehicle to proceed with normal compaction and collection activities.

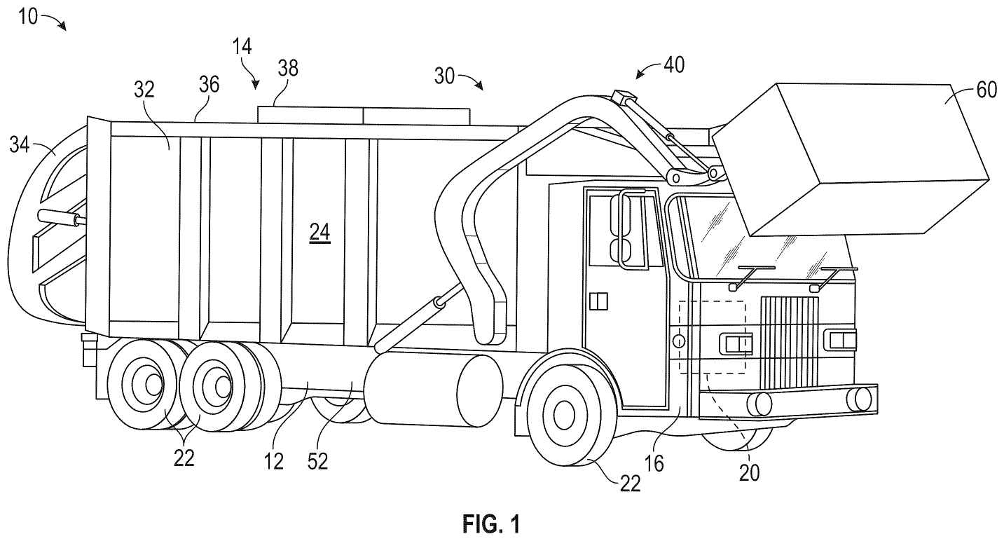

Referring to FIG. 1, a vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 provides power to a plurality of motive members, shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 20 may be configured to use a variety of fuels (e.g., gasoline, diesel, biodiesel, ethanol, natural gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an on-board refuse container. In the embodiment of FIG. 1, the body 14 and on-board refuse container, in particular, defines a collection chamber 24. In some embodiments, the body 14 includes a plurality of panels, shown as panels 32, a tailgate 34, and a cover 36 that together define the collection chamber 24. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the on-board refuse container and is positioned at the rear end of the body 14. The tailgate 34 is configured to pivot about pivot pins positioned along the top surface of the on-board refuse container. In other embodiments, a different connection mechanism may be used to support the tailgate 34 on the body 14.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

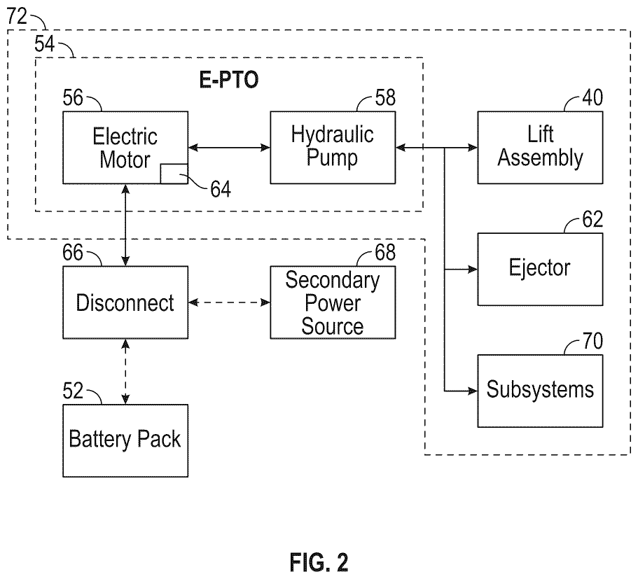

Referring to FIG. 2, in embodiments in which the refuse vehicle is an electric refuse vehicle (e.g., an E-refuse vehicle, etc.) or a hybrid refuse vehicle (e.g., a vehicle including both electric and hydraulic power systems, etc.), the refuse vehicle may further include an onboard energy storage device. In some embodiments, the onboard energy storage device includes a battery pack 52 that provides power to a motor that produces rotational power to drive the refuse vehicle. The energy storage device can be used to provide power to different subsystems on the refuse vehicle. The refuse vehicle may also include an electric power take-off (E-PTO) system, shown as E-PTO system 54, that is configured to receive electrical power from the battery pack 52 and/or other power sources (such as a hydrogen fuel cell 68) and to convert the electrical power to hydraulic power for different subsystems on the refuse vehicle. In some embodiments, the E-PTO system 54 receives electrical power from the energy storage device and provides the electrical power to an electric motor 56. In such embodiments, the electric motor 56 may drive a hydraulic pump 58 that provides pressurized hydraulic fluid to different vehicle subsystems, such as the lift assembly 40, the packer/ejector, shown as ejector 62, or other subsystems 70 (e.g., the tailgate, etc.). In some embodiments, an auxiliary subsystem 72 comprises the E-PTO system 54, the lift assembly 40, the ejector 62, and/or various other subsystems 70.

The E-PTO system may include an E-PTO controller 64. The E-PTO controller 64 may monitor various systems within the refuse vehicle, including the E-PTO system 54. The E-PTO controller 64 may receive data from sensors (not shown) within the system, compare the data to expected values under normal operating conditions, adjust the operation parameters of components of the system, and determine if a critical operating condition exists based on the sensor data. Further, the E-PTO controller 64 may shut down the system and/or the refuse vehicle in response to detecting a critical operating condition. In some embodiments, the refuse vehicle further includes a disconnect 66 positioned between the battery pack 52 and the E-PTO system 54 to allow different vehicle subsystems (e.g., the ejector 62, the lift assembly 40, etc.) to be decoupled and de-energized from the electrical power source. For example, the E-PTO controller 64 may cause the disconnect 66 to be decoupled and de-energized from the electrical power source.

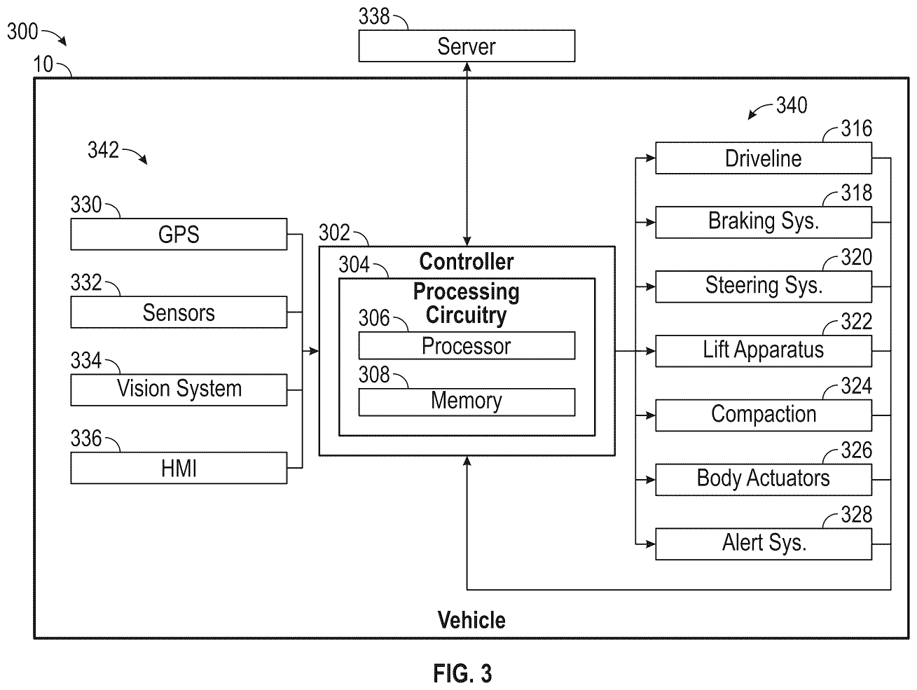

Referring to FIG. 3, the refuse vehicle 10 may include a control system 300 that is configured to facilitate autonomous or semi-autonomous operation of the refuse vehicle 10, or components thereof. The control system 300 includes a controller 302 that is positioned on the refuse vehicle 10, a server 338, one or more input devices 342, and one or more controllable elements 340. The input devices 342 can include a Global Positioning System (“GPS”), multiple sensors 332, a vision system 334 (e.g., an awareness system), and a Human-Machine Interface (“HMI”). The controllable elements 340 can include a driveline 316 of the refuse vehicle 10, a braking system 318 of the refuse vehicle 10, a steering system 320 of the refuse vehicle 10, a lift apparatus 322 (e.g., the lift assembly 40), a compaction system 324 (e.g., a packer assembly, a packer, etc.), body actuators 326 (e.g., tailgate actuators, lift or dumping actuators, etc.), and/or an alert system 328. The body actuators 326 may be operatively coupled to one or more refuse-moving components of the refuse vehicle 10. For example, the body actuators 326 may be (or be a portion of) a front loading arm, a side loading arm, an ejector, or a compactor.

The controller 302 includes processing circuitry 304 including a processor 306 and memory 308. Processing circuitry 304 can be communicably connected with a communications interface of controller 302 such that processing circuitry 304 and the various components thereof can send and receive data via the communications interface. Processor 306 can be implemented as a general purpose processor, an application specific integrated circuit (ASIC), one or more field programmable gate arrays (FPGAs), a group of processing components, or other suitable electronic processing components.

Memory 308 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 308 can be or include volatile memory or non-volatile memory. Memory 308 can include database components, object code components, script components, or any other type of information structure for supporting the various activities and information structures described in the present application. According to some embodiments, memory 308 is communicably connected to processor 306 via processing circuitry 304 and includes computer code for executing (e.g., by at least one of processing circuitry 304 or processor 306) one or more processes described herein. Memory 308 may thus be implemented on a computer-readable, non-transitory storage medium storing instructions that, when executed by one or more processors (such as the processor 306), cause the controller 302 to perform any of the methods or processes described herein.

The controller 302 is configured to receive inputs (e.g., measurements, detections, signals, sensor data, etc.) from the input devices 342, according to some embodiments. In particular, the controller 302 may receive a GPS location from the GPS system 330 (e.g., current latitude and longitude of the refuse vehicle 10). The controller 302 may receive sensor data (e.g., engine temperature, fuel levels, transmission control unit feedback, engine control unit feedback, speed of the refuse vehicle 10, RFID signals, etc.) from the sensors 332. The controller 302 may receive image data (e.g., real-time camera data) from the vision system 334 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, within the compactor of the refuse vehicle 10, etc.). The controller 302 may receive user inputs from the HMI 336 (e.g., button presses, requests to start or stop a lifting or loading operation, driving operations, steering operations, braking operations, safety override, alert clearance, etc.).

The controller 302 may be configured to provide control outputs (e.g., control decisions, control signals, etc.) to the driveline 316 (e.g., the engine, the transmission, the engine control unit, the transmission control unit, etc.) to operate the driveline 316 to transport the refuse vehicle 10. The controller 302 may also be configured to provide control outputs to the braking system 318 to activate and operate the braking system 318 to decelerate the refuse vehicle 10 (e.g., by activating a friction brake system, a regenerative braking system, etc.). The controller 302 may be configured to provide control outputs to the steering system 320 to operate the steering system 320 to rotate or turn at least two of the wheels 22 to steer the refuse vehicle 10. The controller 302 may also be configured to operate actuators or motors of the lift apparatus 322 (e.g., lift assembly 40) to perform a lifting operation (e.g., to grasp, lift, empty, and return a refuse container). The controller 302 may also be configured to operate the compaction system 324 to compact or pack refuse that is within the refuse compartment 30. The controller 302 may also be configured to operate the body actuators 326 to implement a dumping operation of refuse from the refuse compartment 30 (e.g., driving the refuse compartment 30 to rotate to dump refuse at a landfill). The controller 302 may also be configured to operate the alert system 328 (e.g., lights, speakers, display screens, etc.) to provide one or more aural or visual alerts to nearby individuals.

The controller 302 may also be configured to receive feedback from any of the driveline 316, the braking system 318, the steering system 320, the lift apparatus 322, the compaction system 324, the body actuators 326, or the alert system 328. The controller may provide any of the feedback to the server 338 via a communications interface (not shown). The communications interface may include any wireless transceiver, cellular dongle, communications radios, antennas, etc., to establish wireless communication with the server 338. The communications interface may facilitate communications with nearby refuse vehicles 10 to thereby establish a mesh network of refuse vehicles 10.

The controller 302 is configured to use any of the inputs from any of the GPS system 330, the sensors 332, the vision system 334, or the HMI 336 to generate controls for the driveline 316, the braking system 318, the steering system 320, the lift apparatus 322, the compaction system 324, the body actuators 326, or the alert system 328. In some embodiments, the controller 302 is configured to operate the driveline 316, the braking system 318, the steering system 320, the lift apparatus 322, the compaction system 324, the body actuators 326, and/or the alert system 328 to autonomously transport the refuse vehicle 10 along a route (e.g., self-driving), perform pickups or refuse collection operations autonomously, and transport to a landfill to empty contents of the refuse compartment 30. The controller 302 may receive one or more inputs from the server 338 such as route data, indications of pickup locations along the route, route updates, customer information, pickup types, etc. The controller 302 may use the inputs from the server 338 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the server 338 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The server 338 may perform any of the route planning techniques as described in greater detail in U.S. application Ser. No. 18/111,137, filed Feb. 17, 2023, the entire disclosure of which is incorporated by reference herein. The server 338 may implement any route planning techniques based on data received by the controller 302. In some embodiments, the controller 302 is configured to implement any of the cart alignment techniques as described in U.S. application Ser. No. 18/242,224, filed Sep. 5, 2023, the entire disclosure of which is incorporated by reference herein. The refuse vehicle 10 and the server 338 may also operate or implement geofences as described in greater detail in U.S. application Ser. No. 17/232,855, filed Apr. 16, 2021, the entire disclosure of which is incorporated by reference herein.

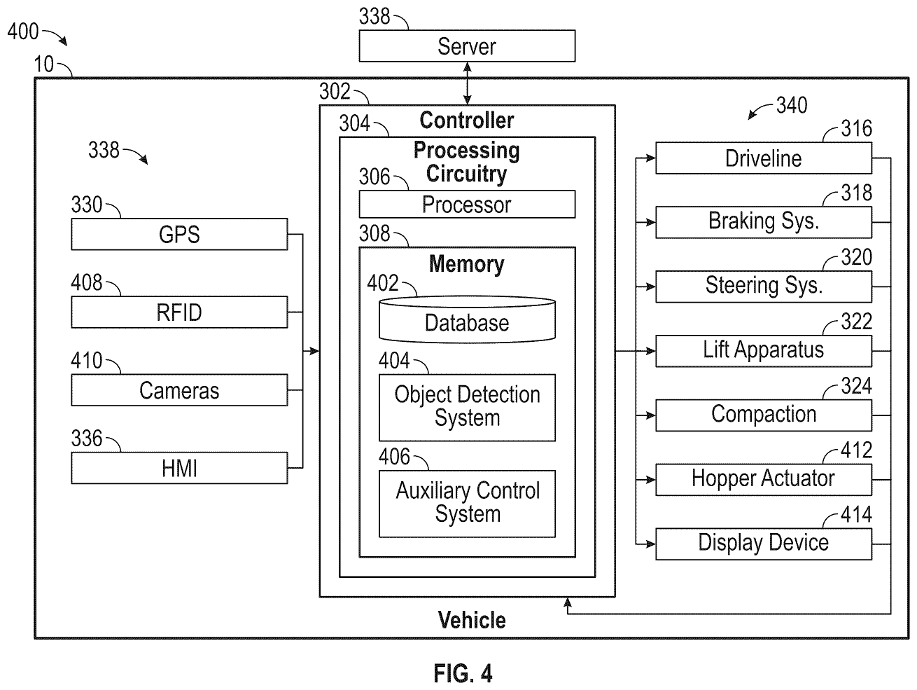

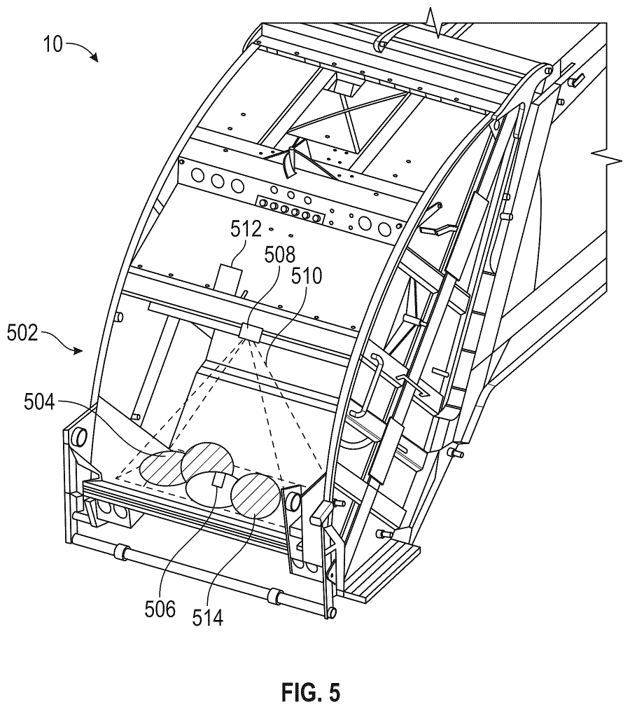

Turning now to FIG. 4, the memory 308 of the controller 302 includes a database 402, an object detection system 404, and an auxiliary control system 406. The object detection system 404 may obtain image data from the cameras 410 of the hopper that are within the perception area the cameras 410 (e.g., a perception area 510 of FIG. 5). The image data captured from this perception area constitutes a perception dataset that the object detection system 404 can analyze as described herein. The object detection system 404 implemented by the processing circuitry 304 of the controller 302 is performed in order to identify types of objects within the hopper and/or compaction compartment of the vehicle 10 in order to determine whether objects in the hopper and/or compaction compartment are refuse or non-refuse. In some embodiments, non-refuse objects include objects that are not permitted to be discarded. Examples of non-refuse objects may include aerosol cans, liquids, animals, antifreeze, appliances, asbestos, barrels, batteries, chemical products, computers, contaminated oils (mixed with solvents, gasoline, etc.), dirt/soil, fluorescent tubes, hazardous waste, herbicides and pesticides, persons, industrial waste, lead-based painted debris, lubricating/hydraulic oil, medical waste, microwaves, mattresses, monitors, motor oil, oil filters, other flammable liquids, paint (except dried latex paint cans, no liquids), PCB/PCB-containing material, propane tanks, radioactive material, railroad ties, solvents, televisions, tires, transmission oil, concrete, bricks, and/or demolition material. While non-refuse objects may include non-permitted objects intentionally placed within a cart for collection, non-refuse object may also include objects unintentionally placed in the hopper of the refuse vehicle. For example, an operator or other person may unintentionally fall into the hopper. In such cases, the operator or other person is detected as a non-refuse object. Refuse objects may, in some embodiments, be all other objects not determined to be non-refuse.

The object detection system 404 may be configured to implement any machine learning, neural network, or artificial intelligence in order to identify whether the object within the hopper of the vehicle 10 is refuse or non-refuse (e.g., to predict a type of refuse within the refuse container). For example, the controller 302 may implement the object detection system 404 by performing any of the functionality as described in greater detail in U.S. application Ser. No. 16/758,834, filed Apr. 23, 2020, the entire disclosure of which is incorporated by reference herein. The object detection system 404 may be implemented locally on the controller 302 or remotely by the server 338.

An RFID sensor 408 may also be configured to receive an RFID response from an RFID tag. The object detection system 404 may analyze the RFID response to determine, based on the RFID response, a location of the RFID in relation to the hopper. In an embodiment, the RFID tag is coupled to an operator (e.g., coupled to a wearable device worn or carried by the operator such as a lanyard, vest, pin, clip, device, jacket, hat, belt, sash, card).

The object detection system 404 may be configured to detect, using the above-described functionality, the presence of a non-refuse object within the hopper of the vehicle 10 and provide the detection results to the auxiliary control system 406 and/or the display device 414.

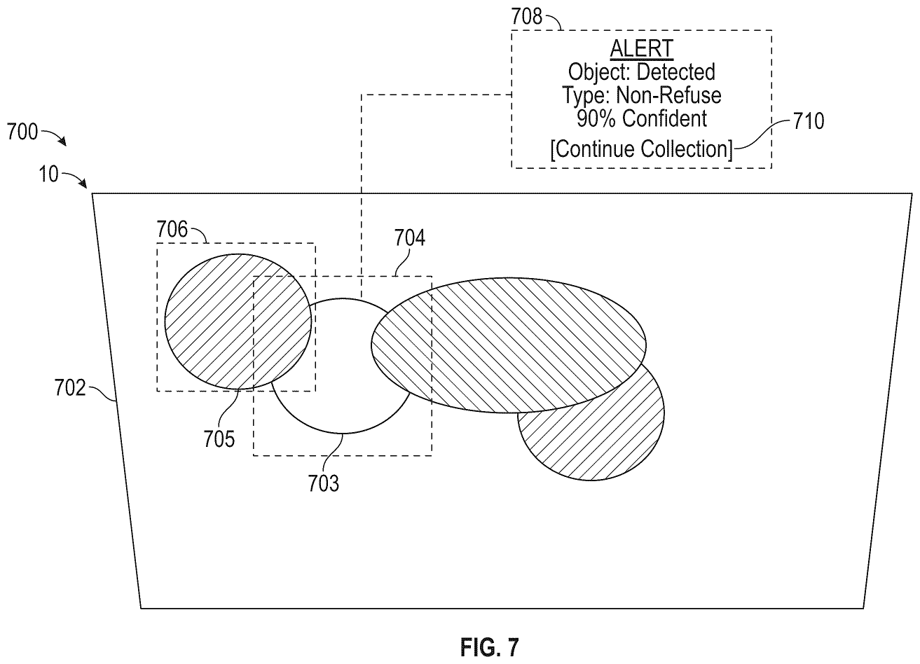

The auxiliary control system 406 is configured to receive the results of the object detection system 404 and, in response, operate at least one of the driveline 316, braking system 318, the steering system 320, lift apparatus 322, the compaction system 324, and/or a hopper actuator 412. For example, in response to receiving an indication from the object detection system 404 that a non-refuse object is present within the hopper of the vehicle (either by a received RFID signal or image processing), the auxiliary control system 406 may transmit control signals to instruct the driveline 316 to stop operation, the braking system 318 to brake the vehicle 10, stop refuse collection by the lift apparatus 322, halt the compaction system 324 from compacting refuse within the refuse vehicle 10, stop the hopper actuator 412 from directing refuse into the body of the vehicle 10, and/or display an alert on an operator interface of the refuse vehicle 10 (as shown in FIG. 7).

In some embodiments, the auxiliary control system 406 may additionally or alternatively reverse operation of one or more of the one or more controllable elements 340. For example, upon receiving an indication of a non-refuse object within the hopper of the vehicle 10, the auxiliary control system 406 may transmit control signals with instructions to the hopper actuator 412 to reverse operation from directing refuse into the body of the refuse vehicle 10, reverse operation of the lift apparatus 322 to stop dumping refuse into the hopper and replace the collected cart, and/or reverse operation of the compaction system 324 from compacting refuse.

In some embodiments, the auxiliary control system 406, upon receiving an indication of the non-refuse object within the hopper of the refuse vehicle 10 and transmitting control signals to the one or more controllable elements 340 and/or transmitting an alert to the display device 414, may require receipt of an indication overriding the alert or detection of the non-refuse object. The indication may come from a user input through the HMI 336 such as by selection of a selectable element on the display device 414 or a depression of a button of the HMI 336. In other embodiments, the HMI 336 may be at the entrance of the hopper of the vehicle 10. Thus, requiring an operator of the refuse vehicle 10 to physically be present at the hopper to indicate removal of the non-refuse object or non-presence of non-refuse objects. In other embodiments, the display device 414 may display a video or image stream of the hopper of the refuse vehicle 10 to the operator of the vehicle within the cab of the vehicle 10, such as shown in FIG. 7.

FIG. 5 illustrates at least one embodiment of the systems and methods described herein in connection with the refuse vehicle 10, particularly focusing on components and sensor configurations for detecting objects within a perception area proximate to or within a refuse compartment. As shown, the refuse vehicle 10 includes a back-loading hopper 502, which serves as part of the refuse compartment into which waste material is deposited prior to compaction. The back-loading hopper 502 is equipped with at least one image sensor 508 and at least one RFID sensor 512, both coupled to the hopper 502 and configured to generate a perception dataset corresponding to a defined perception area.

The image sensor 508 may include a camera or multi-frame imaging system that has a perception area 510 aligned with a spatial region inside the back-loading hopper 502. This perception area 510 is defined to capture data from within the refuse compartment, enabling the sensor to record images or video frames of objects deposited into the hopper. These frames may form a perception dataset, which is transmitted to a controller of the refuse vehicle 10 and used by one or more processors to detect and classify objects. The system is configured to detect an object within the perception area based on the perception dataset and to determine whether the object is a refuse object or a non-refuse object.

A refuse object 504 may include any object that is permitted to be compacted or processed by the refuse vehicle, such as bagged household waste, cardboard, or plastic containers. In contrast, a non-refuse object 506 may include any item that is not permitted within the refuse compartment, whether due to hazard, improper sorting, or unintentional presence. In some embodiments, the non-refuse object 506 may be a person, such as an operator or worker located too close to or within the hopper 502. To facilitate this type of detection, the system may use the RFID sensor 512, which has its own perception area overlapping with that of the image sensor 508.

The RFID sensor 512 may detect signals from an RFID tag 514, which may be embedded in a wearable device (such as a safety vest, badge, or wristband) carried by the operator. When the RFID tag 514 enters the perception area of the RFID sensor 512, the sensor generates a signal indicating the presence of a person within or near the hopper 502. The resulting signal forms part of the perception dataset and is transmitted to the vehicle's controller, where one or more processors analyze the dataset to determine that a non-refuse object is present.

For example, during an early morning collection route, a crew member wearing an RFID-tagged vest briefly leans over the back-loading hopper 502 to clear a jammed item. The RFID sensor 512 detects the tag 514 within its perception area and sends the corresponding signal to the controller. Simultaneously, the image sensor 508 captures frames showing the crew member's upper body within the hopper. The controller receives this perception dataset and, based on the presence of a wearable RFID tag and body geometry data extracted from the images, classifies the object as a non-refuse object. In response, the controller transmits a control signal to adjust an operation of the actuator—specifically halting the compaction sequence and preventing ejection until the object is cleared.

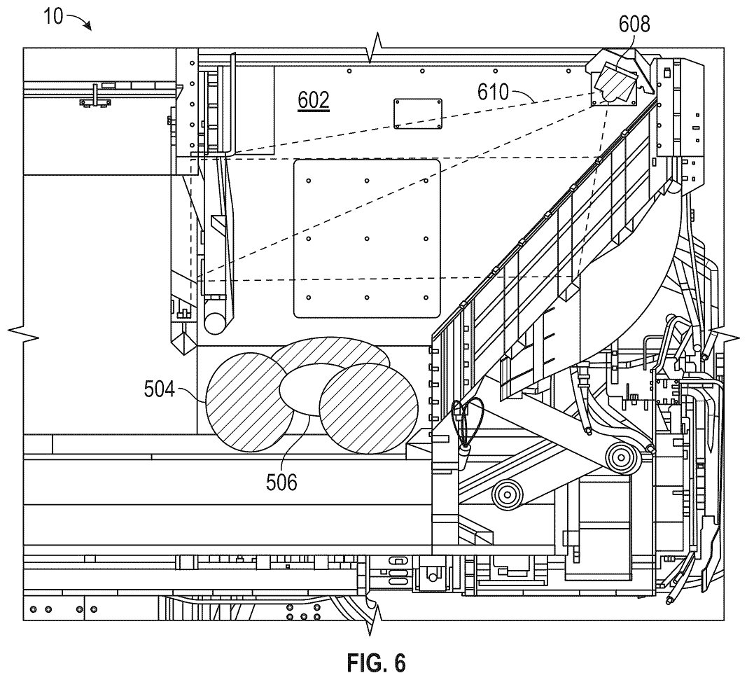

FIG. 6 illustrates an alternative embodiment of the systems and methods described herein, in which the refuse vehicle 10 includes a top-loading hopper 602 that forms part of the refuse compartment of the vehicle. The hopper 602 is configured to receive refuse objects and may be accessed by a lift mechanism or manually loaded from above. Coupled to the top-loading hopper 602 is a sensor, shown as a camera 608, which is configured to capture sensory data within a defined perception area 610. The perception area 610 corresponds to a region proximate to or within the hopper 602 and includes the spatial volume where objects accumulate during loading or prior to compaction. The camera 608 generates a perception dataset comprising image data of any objects that enter or remain within this perception area 610.

This perception dataset is transmitted to one or more processors of the controller 302, which are configured to detect the presence of an object within the perception area and determine, based at least on the perception dataset, whether the object is a non-refuse object. The system may analyze object geometry, color, texture, or relative motion to differentiate between permitted refuse and prohibited or hazardous materials. If the object is determined to be non-refuse, the controller transmits a control signal to adjust an operation of an actuator, such as halting a packer actuator or preventing further loading into the hopper 602. In some cases, the actuator may be a gate actuator configured to open or close access to the compaction chamber, and the control signal prevents the gate from opening until the object is cleared.

The perception area 610, while shown to occupy the interior volume of the hopper 602, may additionally or alternatively encompass the dump trajectory or tipping arc of refuse containers lifted by the vehicle's collection mechanism. This allows the system to analyze objects in transit—i.e., between the container and the hopper—so that non-refuse items can be detected before full deposit into the refuse compartment. For instance, as a commercial refuse container is lifted and tipped into the top-loading hopper 602, the camera 608 captures image frames that reveal an unbagged lead-acid battery sliding into the hopper. Based on visual characteristics of the object, the system classifies it as a non-refuse object and transmits a control signal to an actuator responsible for compaction, halting the actuator before the battery is engaged.

By situating the camera 608 above the top-loading hopper 602 and defining a perception area 610 that encompasses both the internal and ingress zones of the hopper, the system is capable of real-time hazard identification and proactive control signal generation. This enables enforcement of waste compliance rules and reduces the risk of equipment damage or environmental violation. Additionally, the object classification logic, including the determination that an object is non-refuse, may be stored and executed from a computer-readable, non-transitory storage medium included in memory 308.

Turning now to FIG. 7, a graphical user interface 700 is shown with one or more interactive elements 710. The graphical user interface 700 may be a transmitted view of a vehicle's hopper. The view may correspond with a perception area of a camera coupled to the vehicle (e.g., the perception area 510 of FIG. 5). Within the graphical user interface 700 may be depictions (whether virtual or captured) of objects within the hopper such as object 703 and object 705. The non-refuse detection system 400 of FIG. 4 may be executed to display the graphical user interface 700 of FIG. 7. For example, the memory 308 of the controller 302 may include various stored modules or subsystems that, when executed by the processing circuitry 304 cause the controller 302 to perform one or more computer-implemented methods. For example, the memory 308 may include a display manager (not shown) that may be configured to generate display data and operate the display device 414 to provide display data to an operator of the refuse vehicle 10 or a user that remotely controls or monitors the refuse vehicle 10. The display data may include various callouts 704, 706, 708 overlaid or superimposed onto a real-world or digital image of the hopper 702. The callouts 704, 706, 708 may indicate the results of the object detection system 404 of FIG. 4 and can include lines indicating the corresponding features. For example, as shown in FIG. 7, the display data may include a first callout 704 or visual indication that indicates the results of an object detection or object-type detection of an object 703. The display data may also include a second callout 708 or visual indication that indicates the results of image analysis of particular features of the object 703 (e.g., an object detection, an object type, a confidence level, and/or a selectable input to override the alert). The display data may also include a third callout 706 indicating the presence of a detected object 705.

Upon identifying the object 703 and/or displaying the alert with the second callout 708, the object detection system 404 may adjust operation of one or more functions of the refuse vehicle 10. Such adjustments may include stopping a hopper actuator from directing refuse from the hopper into the body of the refuse vehicle 10, stopping movement of the refuse vehicle 10, stopping compaction of refuse within the refuse vehicle 10, stopping collection of a cart, presenting audible alerts and/or tactile alerts.

In some embodiments, upon determining the presence of the object 703 within the hopper 702 and/or displaying the alert in various callouts 708, the non-refuse detection system 400 may require receipt of an alert override, such as an indication of a selection of the one or more interactive elements 710. The graphical user interface depicted in FIG. 7 may present a live or substantially live stream of the contents of the hopper 702 on a display device to the user within the cab of the refuse vehicle 10, facilitating a manual review of the contents of the hopper 702 to determine if the object 703 is, indeed, non-refuse. In some embodiments, the user is able to make a selection to override the alert from within the cab. In some embodiments, the overriding selection may come from a user interface positioned on an exterior of the vehicle, thus facilitating a visual inspection of the hopper 702. Other sources of the overriding indication may come from sensing a reduction in weight from a seat (e.g., a switch sensing a user leaving a seat) or sensing a door to the refuse vehicle 10 opening. In some embodiments, a user's input to operate the vehicle provides the overriding indication (e.g., pressing on a brake or acceleration pedal). In some embodiments, the refuse vehicle 10 is operated and/or supervised remotely. In such embodiments. The overriding indication may come from a remote server communicably coupled to the refuse vehicle 10. Upon receiving an override indication identifying the object as refuse from a user input, the controller 302 transmits a second control signal to resume operation of the actuator, allowing the refuse vehicle 10 to resume operation, either manually or automatically. It should be understood that while FIGS. 5-7 as described herein refer to only two types of object (refuse and non-refuse), the non-refuse detection system 400 may be configured to identify any number of types of objects, refuse, and/or refuse containers using the techniques described herein. For example, the non-refuse detection system 400 may detect items/object not permitted by the refuse management entity and use GPS location received from the GPS system 330 to charge a client associated with the GPS location for disposing of non-permitted objects. The non-refuse detection system 400 may also be configured to detect recyclables.

The non-refuse detection system 400 may further classify individual objects within the hopper according to a predefined object-type hierarchy, which may be implemented using bounding boxes, feature descriptors, or segmentation masks generated from the perception dataset. The object detection system 404 may label each detected item with an object type classification, such as “refuse,” “recyclable,” or a more specific designation like “hazardous,” “prohibited,” or “live entity.” These classifications may be based on training data annotated with prior examples of known object types and can be refined over time using supervised learning or federated learning techniques deployed across multiple refuse vehicles. Once labeled, each object may be associated with a corresponding response profile—for instance, an identified aerosol can may trigger actuator stoppage and user confirmation, whereas an identified recyclable item may be logged for route optimization or educational feedback to the customer. In some embodiments, the system may assign confidence scores to the object type classification, such that lower-confidence classifications prompt alerts but allow continued operation, while high-confidence non-refuse classifications automatically initiate control signals to adjust an operation of the actuator. The ability to classify and respond differently to each object type allows the refuse vehicle to implement nuanced operational logic that improves safety, regulatory compliance, and customer accountability.

In one example, the non-refuse detection system 400 identifies a prohibited item (e.g., a large lithium-ion battery) disposed of in the hopper. The system classifies the battery as a non-refuse object and automatically halts the compaction process, while transmitting instructions to display an alert identifying the object as non-refuse on the operator's interface. Additionally, the system can log the event (e.g., store a record in the database 402 of memory 308, which is maintained on a computer-readable, non-transitory storage medium) and utilize location data (for instance, GPS coordinates from the GPS system 330) to identify the customer associated with that pickup location. The system may then trigger a billing event to charge the customer for disposing of the non-permitted object, as per the policies of the refuse management entity. In another scenario, the non-refuse detection system 400 may detect recyclable materials improperly mixed with general refuse. In such instances, the system might not stop the vehicle's operations but can flag the presence of recyclables and transmit an alert or notification to the operator or a backend system, thereby facilitating appropriate handling or sorting of those materials.

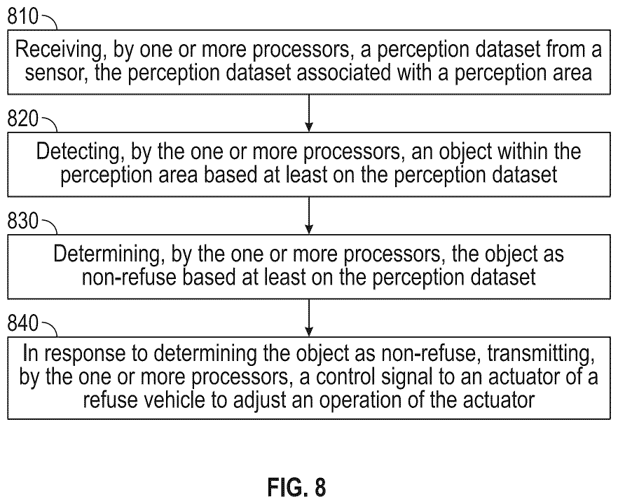

FIG. 8 illustrates an example computer-implemented method that may be executed by one or more processors of a refuse vehicle system, such as the controller 302 described with reference to FIG. 4. The method generally relates to adjusting an operation of an actuator in response to detection of a non-refuse object within a perception area proximate to or within a refuse compartment of the vehicle. This process reflects the underlying logic used by the non-refuse detection system 400, which may incorporate input from one or more sensors (e.g., image sensors, RFID sensors) to generate a perception dataset for analysis. The method shown in FIG. 8 supports the broader system architecture discussed throughout the present description, including the hardware configurations illustrated in FIGS. 1-7 and the object classification logic described in connection with the object detection system 404 and auxiliary control system 406.

While FIG. 8 is presented as a flowchart for purposes of clarity and explanation, the steps illustrated may be performed in a different order or in parallel, and some steps may be omitted, repeated, or combined without departing from the scope of the disclosed embodiments. Additionally, although the steps are described as being performed by particular components (e.g., one or more processors, sensors, or actuators), any of the operations may be implemented by one or more computing devices operating individually or in coordination, including distributed or cloud-based architectures. The method may be embodied as a set of executable instructions stored on a computer-readable, non-transitory storage medium and executed by one or more processors, or implemented in whole or in part as dedicated hardware logic. Accordingly, the scope of FIG. 8 should not be limited by the particular order or implementation details shown, but rather understood to represent an example embodiment of the decision-making logic applicable to the systems and methods disclosed herein.

At step 810, the method includes receiving, by one or more processors, a perception dataset from a sensor, the perception dataset corresponding to a perception area proximate to or within a refuse compartment of a refuse vehicle. The sensor may include, for example, an image sensor such as a camera or a proximity-based sensor such as an RFID sensor configured to monitor the region (e.g., the perception area) of the hopper where refuse is deposited. The perception dataset may comprise one or more images, signal values, depth maps, or RFID tag reads that reflect the contents or conditions within the defined perception area. This perception area may be defined spatially to include regions of the hopper, compaction chamber, or transitional zones between the lift assembly and the interior of the refuse compartment.

For example, in one embodiment, the sensor comprises a camera mounted above the hopper that periodically captures image frames each time refuse is deposited. Each image frame is treated as part of the perception dataset and is received by the controller 302 for analysis. The perception area associated with the camera includes the entire volume of the hopper in which refuse is collected prior to compaction. In another embodiment, the sensor is an RFID sensor positioned near the entrance to the hopper, and the perception dataset includes RFID tag identifiers detected in proximity to or within the refuse compartment.

At step 820, the method includes detecting, by one or more processors, an object within the perception area based at least on the perception dataset. The perception dataset, as previously received from a sensor monitoring the hopper or other portion of the refuse compartment, is analyzed to identify the presence and characteristics of one or more discrete objects located within the defined perception area. This detection process may include parsing image data to locate object boundaries, extracting signal patterns from RFID reads, or identifying clusters of data points corresponding to physical articles.

For instance, in an example implementation where the perception dataset comprises one or more images captured by a camera, the one or more processors may apply an object recognition model—such as a convolutional neural network (CNN)—to identify the bounding boxes of individual items visible in the hopper. These items may vary in size, shape, or material composition, and may include bags, containers, loose items, or bulk materials. In another embodiment, where the perception dataset originates from an RFID sensor, detecting an object may include registering a valid RFID tag transmission from a tag located within the hopper and associating that tag with a predefined object type (e.g., operator, wearable device, or tagged container).

At step 830, the method includes determining, by one or more processors, that the object detected within the perception area is a non-refuse object, based at least on the perception dataset. This determination may be carried out by applying classification logic to the detected object using features extracted from the perception dataset, which may include visual characteristics, sensor signal patterns, or metadata such as RFID tag identifiers. The classification process may utilize a rule-based system, a statistical classifier, or a trained machine learning model to assign the object to a category, such as “refuse” or “non-refuse.”

For example, in an embodiment where the perception dataset consists of camera images, the one or more processors may analyze the shape, size, color, and surface texture of the object to classify it as a non-refuse object, such as an aerosol can, a propane cylinder, or a live animal. The classifier may determine, based on a high-confidence match to training data, that the item poses a safety risk or is otherwise prohibited by the waste management entity. In another example, if the perception dataset includes an RFID signal detected from a wearable safety device carried by an operator, the one or more processors may classify the source of that signal as a human presence within the hopper. Based on predefined mappings stored on a computer-readable, non-transitory storage medium, the system identifies the object as a non-refuse object.

At step 840, the method includes transmitting, by one or more processors, a control signal to an actuator of the refuse vehicle to adjust an operation of the actuator. This step is performed in response to the determination, at step 830, that an object located within a perception area proximate to or within the refuse compartment is a non-refuse object. The control signal may be configured to modify the operation (e.g., reverse direction, stop, accelerate, decelerate) of one or more actuators responsible for auxiliary functions of the vehicle, such as compaction, ejection, or collection. The actuator receiving the control signal may include, for example, a compaction actuator, a hopper actuator, front loading arm, side loading arm, ejector, compactor, or a lift actuator. Depending on the configuration of the refuse vehicle and the specific auxiliary function underway, the control signal may initiate a range of possible adjustments.

For example, if the non-refuse object is detected during the compaction cycle, the control signal may pause, stop, or retract the compaction actuator to prevent the object from being crushed. If the actuator is part of a reciprocating packer system, the signal may cause the system to reverse its stroke or enter a hold state until the object is cleared or confirmed. If the non-refuse object is detected during dumping into the hopper, the control signal may instruct a hopper actuator to delay or cancel an automatic sweeping or indexing motion intended to move refuse further into the compaction zone.

In embodiments involving automated cart collection, the control signal may adjust operation of the lift actuator by halting the lift mid-cycle, reversing the lift arm to return the cart to the ground, or locking the lift in place to prevent motion until operator intervention. For side-loading vehicles, the signal may further deactivate a clamp actuator to prevent the cart from being tipped entirely into the hopper. In vehicles with automated tailgate actuators or ejector actuators, the control signal may postpone or interrupt an ejection sequence if a non-refuse object is detected during rear discharge procedures.

The control signal may also be used to adjust secondary actuators, such as closing a compactor access door, engaging a hydraulic lockout valve, retracting a blade edge away from contact with the object, or disabling a chute gate intended to direct materials into the refuse compartment. These actuator adjustments may be performed individually or in coordinated combinations, depending on system configuration, to ensure that the non-refuse object is not subjected to mechanical processing until further review or clearance occurs.

One example of an adjustment that can be made to the operation of the actuator is reversing its direction. For instance, if the actuator is part of a compaction assembly driving a packer blade forward to compress refuse, the system may transmit a control signal instructing the actuator to reverse direction, causing the blade to retract away from the refuse compartment. This reverse direction adjustment may also be applied to a lift actuator mid-way through raising a refuse cart, where the actuator is directed to reverse direction and lower the cart back to the ground. In the context of a hopper actuator, reversing direction may involve retracting a sweep mechanism to prevent further movement of material toward the compaction chamber. These reverse direction adjustments allow the system to disengage from potentially hazardous or non-permitted objects, ensuring that mechanical interaction is suspended until further action is taken. The command to reverse direction may be initiated automatically upon detection of a non-refuse object, and is one of several possible actuator control strategies executed by the system.

The logic executed to determine the appropriate control signal and actuator behavior may be stored on a computer-readable, non-transitory storage medium and executed by one or more processors.

In one embodiment, the object detection system classifies a pressurized propane cylinder as a non-refuse object based on visual features identified in the perception dataset. In response, the one or more processors of the controller 302 transmit a control signal to the compaction actuator instructing it to pause the compaction sequence immediately, thereby avoiding contact with the potentially hazardous item. Alternatively, the control signal may instruct the actuator to reverse its motion, retracting the compaction blade or opening the hopper gate to allow manual removal of the object. In other scenarios, the system may direct the lift actuator to halt or reverse a cart-dumping operation if a non-refuse object is detected during the lifting sequence.

The control signal may be generated and transmitted based on logic stored in a computer-readable, non-transitory storage medium and executed by one or more processors of the controller 302. This capability allows the refuse vehicle to respond automatically to the presence of non-refuse objects by adjusting an operation of the actuator before the object can be damaged, improperly disposed of, or cause harm to the equipment or personnel.

Following the transmission of the control signal to adjust an operation of the actuator, the system may optionally perform additional actions based on the type or context of the detected non-refuse object. In some embodiments, the one or more processors may initiate a data logging procedure in which information related to the detection event—such as the object type, location, time, confidence score, and sensor data—is recorded to a computer-readable, non-transitory storage medium. This record may be associated with a customer account, a geographic service zone, or a specific refuse collection route.

For example, if the detected non-refuse object is a prohibited item such as a lithium-ion battery, the system may correlate the detection event with GPS coordinates received from the GPS system 330 and use that location to identify the source of the discarded item. The system may then transmit a billing event or violation notice to a central server or customer database, enabling the waste management entity to impose a surcharge or initiate an enforcement action. In some cases, this action may be accompanied by transmission of an image or classification summary to the operator's display device or to a backend compliance system for manual review. These post-detection processes enhance the operational accountability of the refuse vehicle and extend the usefulness of the object classification system beyond real-time actuator control.

In some embodiments, upon determining that an object within the perception area is a non-refuse object, the system may be configured to transmit instructions to a display device to present an alert identifying the object as non-refuse. This alert may include a visual, audible, or tactile signal presented via an operator interface, such as an in-cab touchscreen or external control panel mounted on the vehicle. The alert may indicate, for example, “Non-refuse object detected—compaction paused” or display a live image or highlight surrounding the identified object within a real-time video feed of the hopper.

The instructions transmitted to the display device may include metadata associated with the object classification, such as the classification label, confidence score, or suggested action (e.g., inspect hopper, remove object). This presentation allows the operator to be informed of the system's classification decision and facilitates human-in-the-loop confirmation before resuming actuator operation. In some implementations, the alert may include selectable input elements—such as override buttons or confirm/refuse toggles—that allow the operator to interact with the system in response to the displayed information.

Once a non-refuse object has been identified within the perception area, the system may transmit instructions to a display device to present an alert identifying the object as non-refuse. This alert may be rendered on a user interface within the cab of the refuse vehicle or on an external display accessible to the operator. The alert may include a visual notification such as a warning icon, color-coded indicator, bounding box overlay on a video stream, or textual message describing the classification result (e.g., “Hazardous object detected: Propane Cylinder”). The display may additionally present context-specific information such as time of detection, object type, and the operational status of the actuator.

Following the presentation of the alert, the system may await receipt of an override indication identifying the object as refuse. This override indication may be received through a human-machine interface (HMI), which may include one or more tactile inputs (e.g., a physical button or touchscreen confirmation), gesture-based interfaces, or remote system access via a telematics portal. The override indication serves as a verification input from a human operator or supervisory system confirming that the object, although initially classified as non-refuse, is safe to process or otherwise permissible.

In response to receiving the override indication, the system may transmit to the actuator a second control signal that causes the actuator to resume its previously paused operation. For example, if a compaction actuator had been halted due to the presence of a suspected hazardous item, the second control signal would command the actuator to resume its compaction sequence. In other implementations, the actuator may resume lifting, ejecting, or processing functions depending on the auxiliary function interrupted by the initial detection.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The memory (e.g., memory, memory unit, storage device) may include one or more devices (e.g., RAM, ROM, Flash memory, hard disk storage) for storing data and/or computer code for completing or facilitating the various processes, layers, and modules described in the present disclosure. Such memory may include or be implemented as a computer-readable, non-transitory storage medium. The memory may be or include volatile memory or non-volatile memory and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein, with such code being stored on a computer-readable, non-transitory storage medium.

The present disclosure contemplates methods, systems, and program products embodied on any computer-readable, non-transitory storage medium for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media—specifically including computer-readable, non-transitory storage media—having machine-executable instructions or data structures stored thereon. Such computer-readable, non-transitory storage media can include, by way of example, RAM, ROM, EPROM, EEPROM, or other optical disk storage, magnetic disk storage, or other magnetic storage devices that store desired program code in the form of machine-executable instructions or data structures and that can be accessed by a general-purpose or special-purpose computer or other machine with a processor.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps, with such logic embodied on a computer-readable, non-transitory storage medium.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from the scope of the present disclosure or from the spirit of the appended claims.

What is claimed is:

1. A refuse vehicle comprising:
a body defining a refuse compartment;
a hopper configured to receive refuse;
an actuator;
a sensor coupled to the refuse vehicle;
one or more processors; and
computer-readable, non-transitory storage medium comprising instructions that when executed by the one or more processors cause the one or more processors to perform method comprising:
receiving, from the sensor, a perception dataset of a perception area proximate to or within the refuse compartment;
detecting an object within the perception area based at least in part on the perception dataset;
classifying the object based at least in part on the perception dataset; and
in response to classifying the object as not refuse, transmitting a control signal to adjust an operation of the actuator.

2. The refuse vehicle of claim 1, wherein the method further comprises:
transmitting instructions to display an alert identifying the object as non-refuse;
receiving an override indication identifying the object as refuse; and
in response to receiving the override indication, transmitting to the actuator, a second control signal to resume operation of the actuator.

3. The refuse vehicle of claim 1, wherein the sensor is an RFID sensor.

4. The refuse vehicle of claim 1, wherein the object is a wearable device communicably coupled to the sensor.

5. The refuse vehicle of claim 4, wherein the wearable device communicates with the sensor through one of RFID, WiFi, and Bluetooth.

6. The refuse vehicle of claim 1, wherein the actuator directs the refuse from the hopper to the refuse compartment.

7. The refuse vehicle of claim 1, wherein the actuator is a compactor for compacting the refuse within the refuse compartment.

8. The refuse vehicle of claim 1, wherein the actuator is a lift assembly for directing the refuse into the hopper.

9. The refuse vehicle of claim 1, wherein the control signal includes instructions to at least one of stop the actuator, reverse direction of the actuator, and adjust operation of the actuator.

10. The refuse vehicle of claim 1, wherein the actuator is at least one of a front loading arm, a side loading arm, an ejector, or a compactor.

11. A computer-readable, non-transitory storage medium comprising instructions that when executed by one or more processors, cause the one or more processors to execute a method comprising:
receiving, from a sensor, a perception dataset of a perception area proximate to or within a refuse compartment of a refuse vehicle;
detecting an object within the perception area based at least in part on the perception dataset;
classifying the object based at least in part on the perception dataset; and
in response to classifying the object as not refuse, transmitting a control signal to adjust an operation of an actuator of the refuse vehicle.

12. The computer-readable, non-transitory storage medium of claim 11, wherein the method further comprises:
transmitting instructions to display an alert identifying the object as non-refuse;
receiving an override indication identifying the object as refuse; and
in response to receiving the override indication, transmitting to the actuator, a second control signal to resume operation of the actuator.

13. The computer-readable, non-transitory storage medium of claim 11, wherein the sensor is an RFID sensor.

14. The computer-readable, non-transitory storage medium of claim 11, wherein the object is a wearable device communicably coupled to the sensor.

15. The computer-readable, non-transitory storage medium of claim 14, wherein the wearable device communicates with the sensor through one of RFID, WiFi, and Bluetooth.

16. The computer-readable, non-transitory storage medium of claim 11, wherein the actuator directs refuse from a hopper of the refuse vehicle to the refuse compartment of the refuse vehicle.

17. The computer-readable, non-transitory storage medium of claim 11, wherein the actuator is a compactor for compacting refuse within the refuse compartment.

18. The computer-readable, non-transitory storage medium of claim 11, wherein the actuator is a lift assembly for directing refuse into a hopper of the refuse vehicle.

19. The computer-readable, non-transitory storage medium of claim 11, wherein the control signal includes instructions to at least one of stop the actuator, reverse direction of the actuator, and adjust operation of the actuator.

20. A refuse vehicle comprising:
a body defining a refuse compartment;
a hopper configured to receive refuse;
an actuator;
a camera coupled to the refuse vehicle;
one or more processors; and
computer-readable, non-transitory storage medium comprising instructions that when executed by the one or more processors cause the one or more processors to perform method comprising:
receiving, from the camera, a perception dataset of a perception area proximate to or within the refuse compartment;
detecting an object within the perception area based at least in part on the perception dataset;
classifying the object based at least in part on the perception dataset; and
in response to classifying the object as not refuse, transmitting instructions to adjust an operation of the actuator.
